(19) United States
(12) Patent Application Publication
(10) Pub. No.: US 2015/0183182 A1
(43) Pub. Date: Jul. 2, 2015

(54) MULTI-FUNCTIONAL CUSHION BODY

(71) Applicant: Chao-Yang HUANG, Yuanlin Township (TW)

(72) Inventor: Chao-Yang HUANG, Yuanlin Township (TW)

(21) Appl. No.: 14/144,769

(22) Filed: Dec. 31, 2013

(51) Int. Cl. B32B 3/26; B32B 5/02; B32B 27/40

(52) U.S. Cl. CPC B32B 3/26; B32B 27/40; B32B 5/02; B32B 2266/0278; B32B 2266/04; B32B 2305/026; B32B 2305/022

(57) ABSTRACT

A multi-functional cushion body has a microporous layer, pores of which are filled with cooling objects or heating objects offering a feeling of coolness or warmth in contact with the human skin. The multi-functional cushion body is either of a shoe cushion, footing cushion, back cushion, seat cushion, bra cushion, cupboard deodorizer cushion or antibacterial cushion. The cooling or heating objects in the multi-functional cushion body evaporate slowly, thus extending the service life. The multi-functional cushion body can be fabricated easily due to simple structure.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a cushion body, and more particularly to an innovative one which is designed to prolong the feeling of coolness or warmth with its simple construction and easy-to-fabricate structure.

2. Description of Related Art Including information Disclosed Under 37 CFR 1.97 and 37 CFR 1.98.

A pair of shoes often offers a feeling of coolness or warmth, for example, as disclosed in Taiwan Utility Model No. 100203939 “a liquid-filled shoe cushion structure”, wherein a holding space filled with liquid could be formed by hot pressing in the blank pressing and sealing. Such a bolding structure could be filled with liquids for warming up, but in practice the liquid fitted into the holding space of the shoe cushion structure can evaporated quickly, so the service life is a little short and the structure is a little complicated, meanwhile there is higher demand for the tightness in blank pressing and tiresome fabrication.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the features of the present invention wherein the “multi-functional cushion body” allows the pores of said microporous layer to be filled with cooling objects or heating objects offering a feeling of coolness or warmth in contact with the human skin, the cooling or heating objects in said multi-functional cushion body could be evaporated slowly, thus extending its service life. Meanwhile, it can be fabricated easily due to simple structure, thus improving substantially its economic value.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a partial sectional view of the first preferred embodiment of the present invention.

FIG. 2 is a partial sectional view of the second preferred embodiment of the present invention.

FIG. 3 is a partial sectional view of the third preferred embodiment of the present invention.

### DETAILED DESCRIPTION OF THE INVENTION

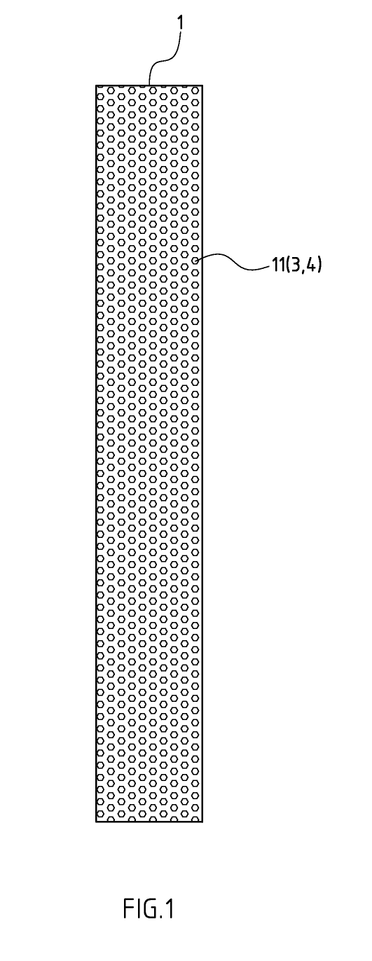

FIGS. 1-3 depict preferred embodiments of a multi-functional cushion body of the present invention, which, however, are provided for only explanatory objective for patent claims.

Said multi-functional cushion body of the present invention comprises either of a shoe cushion, footing cushion, back cushion, seat cushion, bra cushion, cupboard deodorizer cushion or antibacterial cushion. The following description for shoe cushion is conducted, but not limited to it.

### Preferred Embodiment 1

referring to FIG. 1, the preferred embodiment relates to a multi-functional cushion body comprising a microporous layer 1, pores 11 of which are filled with cooling objects 3 offering a feeling of coolness in contact with the human skin or heating objects 4 offering a feeling of warmth in contact with the human skin. For example, the cooling object 3 is peppermint oil, and the heating object 4 is chili oil. The microporous layer 1 is a PU Gel layer, PU foamed layer or silicon layer. Due to smaller pores 11 of the microporous layer 1, the cooling object 3 or heating object 4 could be evaporated slowly from the pores 11 offering a feeling of coolness or warmth. Besides, it is possible to extend the time of coolness or warmth and also fabricate more easily due to simple structure.

### Preferred Embodiment 2

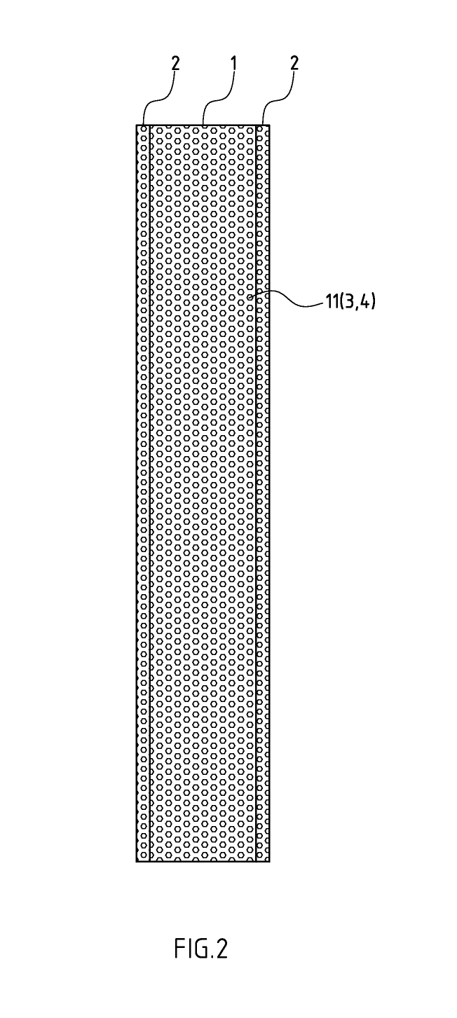

referring to FIG. 2, the preferred embodiment relates to multi-functional cushion body comprising a microporous layer 1, pores 11 of which are filled with cooling objects 3 offering a feeling of coolness in contact with the human skin or heating objects 4 offering a feeling of warmth in contact with the human skin. A TPU layer 2 is covered onto the microporous layer 1. The microporous layer 1 is a PU Gel layer, PU foamed layer or silicon layer. Due to smaller pores 11 of the microporous layer 1 and the pore structure of TPU layer 2, the cooling object 3 or heating object 4 could be evaporated slowly from the pores 11 offering a longer feeling of coolness or warmth. Besides, it can be fabricated more easily due to simple structure.

### Preferred Embodiment 3

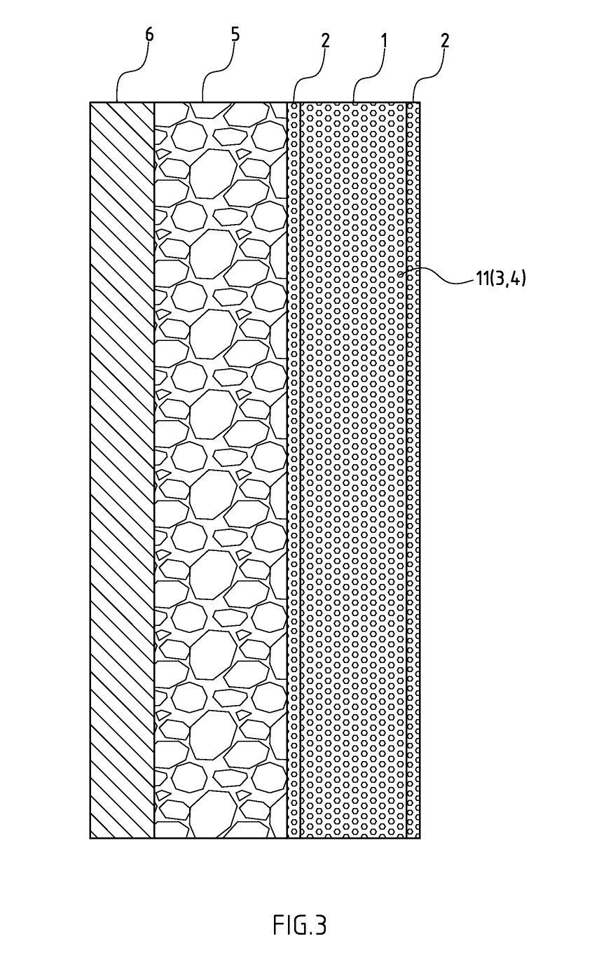

referring to FIG. 3, the preferred embodiment relates to a multi-functional cushion body comprising a microporous layer 1, pores 11 of which are filled with cooling objects 3 offering a feeling of coolness in contact with the human skin or heating objects 4 offering a feeling of warmth in contact with the human skin. A TPU layer 2 is covered onto the microporous layer 1. A foamed cotton layer 5 and a cloth layer 6 are also set onto the microporous layer 1, namely, a foamed cotton layer 5 is bonded onto the TPU layer 2 on the microporous layer 1, and a cloth layer 6 is bonded onto the foamed cotton layer 5. The microporous layer 1 is a PU Gel layer, PU foamed layer or silicon layer. Due to smaller pores 11 of the microporous layer 1 and the pore structure of TPU layer 2, the cooling object 3 or heating object 4 could be evaporated slowly from the pores 11. Besides, as a foamed cotton layer 5 and a cloth layer 6 are set onto the microporous layer 1, the foamed cotton layer 5 and cloth layer 6 without feet pressing could absorb the cooling object 3 or heating object 4 on the microporous layer 1. Or, otherwise the cooling object 3 or heating object 4 within the foamed cotton layer 5 and cloth layer 6 could be evaporated for better effect. The present invention features simple structure, convenient fabrication and better economic benefits.

1. A multi-functional cushion body comprising a microporous layer, pores of which are filled with cooling objects or heating objects offering a feeling of coolness or warmth in contact with the human skin.

2. The structure defined in claim 1, wherein said microporous layer is a PU Gel layer.

3. The structure defined in claim 1, wherein said microporous layer is a PU foamed layer.

4. The structure defined in claim 1, wherein said microporous layer is a silicon layer.

5. The structure defined in claim 1, wherein a TPU layer is covered onto said microporous layer.

6. The structure defined in claim 1, wherein a foamed cotton layer is set onto said microporous layer.

7. The structure defined in claim 5, wherein a foamed cotton layer is set onto TPU layer on said microporous layer.

8. The structure defined in claim 7, wherein a cloth layer is set onto the foamed cotton layer.

9. The structure defined in claim 6, wherein said multi-functional cushion body comprises either of shoe cushion, footing cushion, back cushion, seat cushion, bra cushion, cupboard deodorizer cushion or antibacterial cushion.

10. The structure defined in claim 1, wherein said cooling object is peppermint oil, and said heating object is chili oil.
